(19) United States
(12) Patent Application Publication
(10) Pub. No.: US 2018/0298213 A1
(43) Pub. Date: Oct. 18, 2018

(54) INK COMPOSITIONS

(71) Applicant: HEWLETT PACKARD DEVELOPMENT COMPANY L.P., Fort Collins, CO (US)

(72) Inventors: Jayprakash C. Bhatt, Corvallis, OR (US); Palitha Wickramanayake, Corvallis, OR (US)

(73) Assignee: HEWLETT-PACKARD DEVELOPMENT COMPANY, L.P., Fort Collins, CO (US)

(21) Appl. No.: 15/768,603

(22) PCT Filed: Jan. 22, 2016
(86) PCT No.: PCT/US2016/014543

§ 371 Date: Apr. 16, 2018

(51) Int. Cl. C09D 11/03; C09D 11/107; C09D 11/40; C09D 11/322

(52) U.S. Cl. CPC C09D 11/03; C09D 11/322; C09D 11/40; C09D 11/107

(57) ABSTRACT

The present disclosure is drawn to ink compositions including from 1 wt % to 8 wt % pigment load, and a polymer dispersant associated with pigment, the polymer dispersant having hydrophilic moieties and hydrophobic moieties, a molecular weight ranging from 5,000 Mw to 25,000 Mw, and an acid number from about 40 to about 180. The polymer dispersant to pigment weight ratio can be less than 0.33.

### BACKGROUND

Color pigments are typically dispersed or suspended in a liquid vehicle to be utilized in inks. A variety of colored pigments are difficult to disperse and stabilize in water-based vehicles due to the nature of the surface of pigments and the self-assembling behavior of pigments. One way to facilitate color pigment dispersion and sustained suspension in a liquid vehicle is to adding a dispersant, such as a polymer, to the liquid vehicle. The polymeric dispersant includes hydrophobic and hydrophilic moiety, wherein the hydrophilic moiety may include positive or negative charge. The polymer stabilizes the dispersion and/or suspension of the pigments by virtue of electrostatic and/or steric stabilization. Often, aqueous pigments based inks that are stabilized using polymer can penetrate print media resulting in low color saturation. Thus, enhancing color saturation of polymer dispersed pigments on the print media would be a desirable property to achieve generally.

### BRIEF DESCRIPTION OF THE DRAWINGS

Additional features and advantages of the disclosure will be apparent from the detailed description which follows, taken in conjunction with the accompanying drawings, which together illustrate, by way of example, features of the present technology. It should be understood that the figures are representative examples of the present technology and should not be considered as limiting the scope of the technology.

FIG. 1 depicts a method of preparing an ink in accordance with examples of the present disclosure.

FIG. 2 is a graph depicting enhanced color saturation of pigmented ink that can be achieved by reducing steric stabilization levels of the pigment dispersion in accordance with examples of the present disclosure.

### DETAILED DESCRIPTION

The present disclosure is drawn to ink compositions, ink sets, and methods of making ink compositions. The ink compositions, ink sets, and methods described herein include pigments that remain dispersed or suspended in a liquid vehicle and exhibit enhanced color saturation when printed on media, including various plain media. In accordance with the present disclosure, a polymeric dispersant can be used to disperse or suspend color pigments that would otherwise clump together and settle out of the liquid vehicle. Polymers disperse the pigment by being absorbed or attracted to the surface of the pigment particles. The two principal mechanisms of stabilization are steric stabilization and electrostatic stabilization. Steric stabilization occurs when the outer surface of a colored pigment becomes surrounded by polymer, thereby preventing individual pigments from clumping together. Essentially, adsorbed dispersant polymer on the surface of the pigment produces a strong repulsion between particles and droplets in the dispersion. Electrostatic stabilization occurs when the outer surface of the pigments becomes essentially equally charged. The equal charge on the outer surface of individual colored pigments results in a Coulomb-repulsion that prevents individual colored pigments from clumping together. The ink compositions and methods described herein provide for control of steric stabilization of ink compositions, thereby allowing for the control of color saturation of the ink compositions when printed on print media.

In accordance with this, one example the present technology is drawn to an ink composition including from 1 wt % to 8 wt % pigment load and a polymer dispersant associated with pigment. The polymer dispersant can have hydrophilic moieties and hydrophobic moieties, a molecular weight ranging from 5,000 Mw to 25,000 Mw, and an acid number from about 40 to about 180. The polymer dispersant to pigment weight ratio can be less than 0.33.

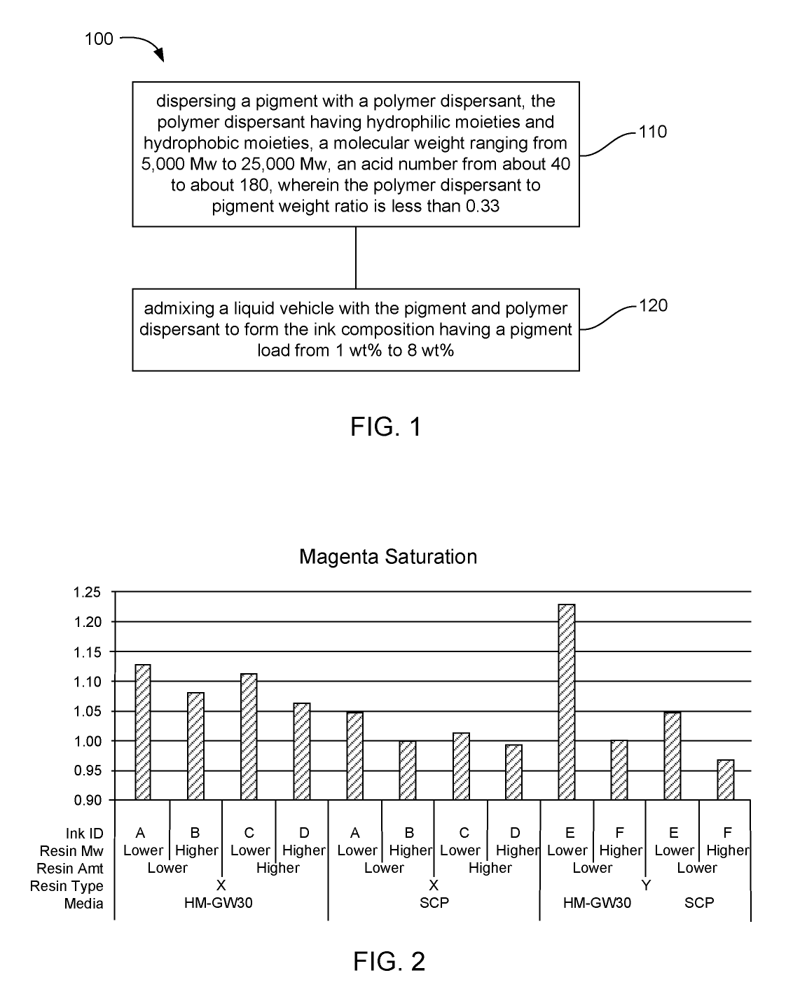

In another example, and as shown in FIG. 1, a method 100 of making an ink composition can include steps of dispersing 110 a pigment with a polymer dispersant, and admixing 120 a liquid vehicle with the pigment and polymer dispersant to form the ink composition having a pigment load from 1 wt % to 8 wt %. The polymer dispersant can have hydrophilic moieties and hydrophobic moieties, a molecular weight ranging from 5,000 Mw to 25,000 Mw, and an acid number from about 40 to about 180. The polymer dispersant to pigment weight ratio can be less than 0.33.

In another example, an ink set can include a magenta ink and at least one of a cyan ink, a yellow ink, or a black ink. The magenta ink can include from 1 wt % to 8 wt % of a magenta pigment load, and a polymer dispersant associated with magenta pigment. The polymer dispersant can have hydrophilic moieties and hydrophobic moieties, a molecular weight ranging from 5,000 Mw to 25,000 Mw, and an acid number from about 40 to about 180. The polymer dispersant to magenta pigment weight ratio can be less than 0.33.

The ink compositions and ink sets disclosed herein exhibit enhanced color saturation on print media. A relationship exists between the effective steric stabilization of the dispersant on the pigment in the ink composition compared to the color saturation of the ink when printed on media provides for these enhanced color saturations. Essentially, by lowering the relative steric stabilization, the color saturation can be enhanced. Lowering the relative steric stabilization of a pigment in an ink can occur by lowering the molecular weight of the hydrophilic/hydrophobic dispersant, as well as lowering the amount of dispersant in the ink relative to the pigment.

With specific reference to the polymer dispersant to pigment weight ratio, as mentioned, a weight ratio less than 0.33 can provided good saturation results. In one specific example, the polymer dispersant to pigment weight ratio can be from 0.1 to 0.29. In another example, the weight ratio can be from 0.15 to 0.25.

Regarding the molecular weight of the dispersants, it has been determined that lower molecular weight polymers tend to provide higher saturation levels. That being said, there is some minimum molecular weight that is used to provide some steric stabilization for the pigment in the ink prior to application to the media substrate. Thus, the polymeric dispersant can have a weight average molecular weight from 5,000 Mw to 25,000 Mw. However, in one example, the weight average molecular weight can be from about 7,000 Mw to about 12,000 Mw.

In one specific example, taking into account pigment load, dispersant to pigment weight ratio, and dispersant molecular weight, one specific ink profile can include a polymer dispersant to pigment weight ratio is from 0.15 to 0.25, a pigment load is from 2 wt % to 6 wt %, and/or a polymer dispersant weight average molecular weight from about 7,000 Mw to about 12,000 Mw. In one example, all three of these parameters are provided in a single ink, e.g., such as a magenta ink, a cyan ink, a yellow ink, or a black ink.

With specific reference to the pigment, the pigment is not particularly limited except where a particular color is desired; and thus, the particular pigment used will depend on the colorists desires in creating the composition. Pigment colorants can include cyan, magenta, yellow, black, red, blue, orange, green, pink, etc. Suitable organic pigments include, for example, azo pigments including diazo pigments and monoazo pigments, polycyclic pigments (e.g., phthalocyanine pigments such as phthalocyanine blues and phthalocyanine greens, perylene pigments, perynone pigments, anthraquinone pigments, quinacridone pigments, dioxazine pigments, thioindigo pigments, isoindolinone pigments, pyranthrone pigments, and quinophthalone pigments), nitropigments, nitroso pigments, anthanthrone pigments such as PR168, and the like. Representative examples of phthalocyanine blues and greens include copper phthalocyanine blue, copper phthalocyanine green and derivatives thereof such as Pigment Blue 15, Pigment Blue 15:3, and Pigment Green 36. Representative examples of quinacridones include Pigment Orange 48, Pigment Orange 49, Pigment Red 122, Pigment Red 192, Pigment Red 202, Pigment Red 206, Pigment Red 209, Pigment Violet 19, and Pigment Violet 42. Representative examples of anthraquinones include Pigment Red 43, Pigment Red 194, Pigment Red 177, Pigment Red 216, and Pigment Red 226. Representative examples of perylenes include Pigment Red 123, Pigment Red 190, Pigment Red 189, and Pigment Red 224. Representative examples of thioindigoids include Pigment Red 86, Pigment Red 87, Pigment Red 198, Pigment Violet 36, and Pigment Violet 38. Representative examples of heterocyclic yellows include Pigment Yellow 1, Pigment Yellow 12, Pigment Yellow 13, Pigment Yellow 14, Pigment Yellow 17, Pigment Yellow 73, Pigment Yellow 90, Pigment Yellow 110, Pigment Yellow 117, Pigment Yellow 120, Pigment Yellow 128, Pigment Yellow 138, Pigment Yellow 150, Pigment Yellow 151, Pigment Yellow 155, and Pigment Yellow 213. Other pigments that can be used include Pigment Blue 15:3, DIC-QA Magenta Pigment, Pigment Red 150, and Pigment Yellow 74. Such pigments are commercially available in powder, press cake, or dispersions form from a number of sources. In one specific example, the ink can be a magenta ink, such as a magenta inkjet ink.

If the colorist desires, two or more pigments can be combined to create novel color compositions, but the polymer dispersant to pigment weight ratio and the total pigment load is to be considered based on the entire pigment load (cumulative based on all pigments). In one example, a pigment combination can form a red ink by combining a magenta pigment and a yellow pigment, e.g. 50-60 wt % magenta pigment and 40-50 wt % yellow pigment. In another example, the pigment combination can form a green ink by combining a yellow pigment and a cyan pigment, e.g., 65-75 wt % yellow pigment and 25-35 wt % cyan pigment. In yet another example, the pigment combination can form a blue ink by combining cyan pigment and magenta pigment, e.g., 85-95 wt % cyan pigment and 5-15 wt % magenta pigment.

The pigments of the present disclosure can be from nanometers to a micron in size, e.g., 20 nm to 1 μm. In one example the pigment can be from about 50 nm to about 500 nm in size. Pigment sizes outside this range can be used if the pigment can remain dispersed and provide adequate printing properties.

The pigment load in the ink compositions can range from 1 wt % to 8 wt %. In one example, the pigment load can be from 2 wt % to 7 wt %. In a further example, the pigment load can be from 2 wt % to 6 wt %. The pigment load is generally less than 8 wt % in ink compositions described herein.

With specific reference to the polymer in these examples, the polymeric dispersant used can be any suitable polymeric dispersant known in the art that is sufficient to form an attraction with the pigment particles, contains acid groups, and includes both hydrophilic moieties and hydrophobic moieties. The ratio of hydrophilic moieties to the hydrophobic moieties can range widely, but in certain specific examples, the weight ratios can be from about 1:5 to about 5:1. In another example, the ratio of hydrophilic moieties to the hydrophobic moieties can range from about 1:3 to about 3:1. In yet another example, the ratio of hydrophilic moieties to the hydrophobic moieties can range from about 1:2 to about 2:1. In one example, the polymeric dispersant can include a hydrophilic end and a hydrophobic end. The polymer can be a random copolymer or a block copolymer or a graft-type (also known as comb) polymer.

The particular polymeric dispersant can vary based on the pigment; however, the hydrophilic moieties typically include acid groups. Some suitable acid monomers for the polymeric dispersant include acrylic acid, methacrylic acid, carboxylic acid, sulfonic acid, phosphonic acid, and combinations of these monomers. The hydrophobic monomers can be any hydrophobic monomer that is suitable for use, but in one example, the hydrophobic monomer can be styrene. Other suitable hydrophobic monomers can include isocyanate monomers, aliphatic alcohols, aromatic alcohols, diols, polyols, or the like, for example. In one specific example, the polymeric dispersant includes polymerized monomers of styrene and acrylic acid at a 5:1 to 1:5 weight ratio.

The weight average molecular weight (Mw) of the polymeric dispersant can vary to some degree, but in one example, the weight average molecular weight of the polymeric dispersant can range from about 5,000 Mw to about 25,000 Mw. In another example, the weight average molecular weight can range from about 7,000 Mw to about 12,000 Mw. In another example, the weight average molecular weight ranges from about 5,000 Mw to about 15,000 Mw. In yet another example, the weight average molecular weight ranges from about 8,000 Mw to about 10,000 Mw.

The acid number of the polymeric dispersant is typically based on the acid groups that are present on the hydrophilic end of the polymeric dispersant. Determining the acid number or acid value is based on the mass of potassium hydroxide (KOH) in milligrams that is used to neutralize one gram of chemical substance. The acid number of the polymeric dispersant can be varied in order to control the electrostatic stabilization of the pigment in the ink composition. The acid number of the polymer can be, for example, from about 40 to about 180. In another example the acid number ranges from about 100 to about 180, or from about 40 to about 150. In yet another example, the acid number can range from about 75 to about 125. These acid values are selected to balance the electrostatic stabilization to maintain stability of pigment dispersion as well as achieve good color saturation on the print media.

The ratio of the polymeric dispersant to pigment in the pigment dispersion can also vary in order to control the steric stabilization of the pigment in the ink composition. Generally the ratio of the polymeric dispersant to pigment is less than about 0.33, e.g., from 0.10 to 0.29. In one example the ratio is less than about 0.25, e.g., from 0.15 to 0.25. In yet another example, the ratio is equal to or less than about 0.2. In a further example, the ratio less than about 0.15. Again, by keeping this value relatively low, steric stabilization can be kept low, even if the acid number is higher or the pigment load is higher in the ink. Again, the present disclosure provides inks with enhanced saturation which is achieved by keeping the steric stabilization low. Retaining lower polymeric dispersant to pigment weight ratios may allow for additional flexibility in other areas.

In order to formulate the pigment dispersion into an ink composition, the pigment dispersion is combined with a liquid vehicle. The liquid vehicle is not particularly limited. The liquid vehicle can include additional polymers, solvents, surfactants, antibacterial agents, UV filters, and/or other additives. However, as part of the ink composition, the pigment is included.

Returning now to the liquid vehicle, solvent of the liquid vehicle can be any solvent or combination of solvents that is compatible with the components of the pigment and polymeric dispersant. Water is typically one of the solvents, and usually, there is one or more organic co-solvent. If an organic co-solvent is added to prepare the pigment dispersion, that co-solvent can be considered when formulating the subsequent ink composition. Examples of suitable classes of co-solvents include polar solvents, such as alcohols, amides, esters, ketones, lactones, and ethers. In additional detail, solvents that can be used can include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. More specific examples of organic solvents can include 2-pyrrolidone, 2-ethyl-2-(hydroxymethyl)-1, 3-propane diol (EPHD), glycerol, N-methylpyrrolidone (NMP), dimethyl sulfoxide, sulfolane, glycol ethers, alkyldiols such as 1,2-hexanediol, and/or ethoxylated glycerols such as LEG-1, etc. The co-solvent can be present in the ink composition from 5 wt % to about 75 wt % of the total ink composition. In one example, the solvent can be present in the ink composition at about 10 wt % to about 50 wt %, or from about 15 wt % to 35 wt %.

Again, water is typically included and can be added in the ink composition and may provide a large portion of the liquid vehicle (sometimes predominantly water, e.g., greater than 50 wt %). In some examples, water may be present in an amount representing from about 20 wt % to about 90 wt %, or may be present in an amount representing from about 30 wt % to about 80 wt % of the total ink composition.

The liquid vehicle can also include surfactants. In general the surfactant can be water soluble and may include alkyl polyethylene oxides, alkyl phenyl polyethylene oxides, polyethylene oxide (PEO) block copolymers, acetylenic PEO, PEO esters, PEO amines, PEO amides, dimethicone copolyols, ethoxylated surfactants, alcohol ethoxylated surfactants, fluorosurfactants, and mixtures thereof. In some examples, fluorosurfactants and alcohol ethoxylated surfactants can be used as surfactants. In one example, the surfactant can be Tergitol™ TMN-6, which is available from Dow Chemical Corporation. The surfactant or combinations of surfactants, if present, can be included in the ink composition at from about 0.001 wt % to about 10 wt % and, in some examples, can be present at from about 0.001 wt % to about 5 wt % of the ink compositions. In other examples the surfactant or combinations of surfactants can be present at from about 0.01 wt % to about 3 wt % of the ink compositions.

Consistent with the formulations of this disclosure, various other additives may be employed to provide desired properties of the ink composition for specific applications. Examples of these additives are those added to inhibit the growth of harmful microorganisms. These additives may be biocides, fungicides, and other microbial agents, which are routinely used in ink formulations. Examples of suitable microbial agents include, but are not limited to, Acticide® (Thor Specialties Inc.), Nuosept™ (Nudex, Inc.), Ucarcide™ (Union carbide Corp.), Vancide® (R.T. Vanderbilt Co.), Proxel™ (ICI America), and combinations thereof. Sequestering agents such as EDTA (ethylene diamine tetra acetic acid) may be included to eliminate the deleterious effects of heavy metal impurities, and buffer solutions may be used to control the pH of the ink. Viscosity modifiers and buffers may also be present, as well as other additives known to those skilled in the art to modify properties of the ink as desired.

The ink compositions described above are particularly suited to provide good color saturation on non-specialized print media (even uncoated paper) but can be suitable for use on any type of substrate of print media. The reason these inks are particularly useful with plain paper is that color saturation is diminished fairly significantly as colorant is soaked into the media substrate. This problem is enhanced when the dispersed pigment is highly stabilized by virtue of high steric stabilization and/or high electrostatic stabilization. Pigment formulators tend to stabilize inks with high electrostatic charges and/or high steric stabilization, but as discussed herein, such high stabilization may not be the best choice for plain paper when trying to enhance color saturation.

Suitable examples of media substrates that can be used include, but are not limited to include, cellulose based paper, fiber based paper, inkjet paper, nonporous media, standard office paper, swellable media, microporous media, photobase media, offset media, coated media, uncoated media, plastics, vinyl, fabrics, and woven substrate. That being described, notably, these inks work surprisingly well on plain paper substrates as described herein.

It is noted herein that the ink compositions, methods, and ink sets are described in some detail with examples related to cyan, magenta, and yellow. However, it is noted that other inks can be prepared using the pigment dispersions described herein, e.g., red ink, a green ink, a blue ink, etc. For example, a red ink can have from 1 wt % to 8 wt % of a red pigment or a mixture of a magenta pigment and a yellow pigment and a polymer dispersant associated with the pigment. The polymeric dispersant can have hydrophilic moieties and hydrophobic moieties, a weight average molecular weight of 5,000 Mw to 25,000 Mw, and an acid number from about 40 to about 180. The weight ratio of the polymeric dispersant to the pigment is less than 0.33. In one specific example the red pigment in the ink composition can be a mixture of about 50 wt % to 60 wt % magenta pigment and 40 wt % to 50 wt % yellow pigment.

A green ink can have from 1 wt % to 8 wt % of a green pigment or a mixture of a cyan pigment and a yellow pigment and a polymeric dispersant associated with the pigment. The polymeric dispersant can have hydrophilic moieties and hydrophobic moieties, a weight average molecular weight of 5,000 Mw to 25,000 Mw, and an acid number from about 40 to about 180. The weight ratio of the polymeric dispersant to the pigment is less than 0.33. In one specific example the pigment load can be a mixture of 65 wt % to 75 wt % yellow pigment and 25 wt % % to 35 wt % cyan pigment.

A blue ink can have from 1 wt % to 8 wt % of a blue pigment or a mixture of a cyan pigment and a magenta pigment and a polymer dispersant associated with the pigment. The polymeric dispersant can have hydrophilic moieties and hydrophobic moieties, a weight average molecular weight of 5,000 Mw to 25,000 Mw, and an acid number from about 40 to about 180. In one specific example the pigment load can be a mixture of 80 wt % to 95 wt % cyan pigment and 5 wt % to 20 wt % magenta pigment.

It is noted that, as used in this specification and the appended claims, the singular forms “a,” “an,” and “the” include plural referents unless the content clearly dictates otherwise.

As used herein “liquid vehicle” refers to a medium in which the pigment and polymeric dispersant are admixed in to form an ink composition. The liquid vehicle can include several components including but not limited to solvents, surfactants, biocides, UN filters, preservatives, and other additives.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

When referring to an increase or improvement in performance, the increase or improvement is based on printing using Hammermill® Great White 30% Recycled Media as the print medium available at the time of filing of the disclosure in the United States Patent and Trademark Office.

### EXAMPLES

The following examples illustrate the technology of the present disclosure. However, it is to be understood that the following is only exemplary or illustrative of the application of the principles of the presented formulations and methods. Numerous modifications and alternative methods may be devised by those skilled in the art without departing from the spirit and scope of the present disclosure. The appended claims are intended to cover such modifications and arrangements. Thus, while the technology has been described above with particularity, the following provide further detail in connection with what are presently deemed to be the acceptable examples.

### Example 1—Preparation of Pigment Ink Composition

Six different magenta inkjet ink compositions were prepared according to the general formulation shown in Table 1, as follows:

TABLE 1
Inkjet Ink Formulation

| Ingredient | Weight % |
|---|---|
| 2-Pyrrolidinone | 9 |
| EHPD | 10 |
| Glycerol | 4 |
| LEG-1 | 0.75 |
| Tergitol TMN6 | 0.6 |
| Acticide B20 | 0.16 |
| Acticide M20 | 0.07 |
| Magenta Pigment Dispersion | *5 |
| Water | Balance |

*5 wt % magenta pigment dispersion is based on the pigment content only. Additional dispersant will be present depending on the ratio of dispersant to pigment. For example, at a dispersant to pigment content ratio of 0.2, there will be 5 wt % pigment and 1 wt % dispersant; or at a ratio of 0.3, there will be 5 wt % pigment and 1.5 wt % dispersant.

Essentially, the six different ink formulations were the same except for three factors: 1) molecular weight of the dispersant; 2) amount of the dispersant; and 3) ratio of styrene and acrylic monomers (described in terms of different acid numbers). The six inks were thus prepared as follows:
Ink A—Dispersant Mw range of 7,000 Mw to 12,000; dispersant to pigment weight ratio of 0.2; and acid number 120.
Ink B—Dispersant Mw of >25,000; dispersant to pigment weight ratio of 0.2; and acid number 120.
Ink C—Dispersant Mw range of 7,000 Mw to 12,000; dispersant to pigment weight ratio of 0.3; and acid number 120.
Ink D—Dispersant Mw of >25,000; dispersant to pigment weight ratio of 0.3; and acid number 120.
Ink E—Dispersant Mw range of 7,000 Mw to 12,000; dispersant to pigment weight ratio of 0.2; and acid number 90.
Ink F—Dispersant Mw of >25,000; dispersant to pigment weight ratio of 0.2; and acid number 90.

To provide a relative comparison in chart form, relative “lower” and “higher” labels were placed on each ink sample with respect to weight average molecular weight and amount of resin present, as shown in Table 2:

TABLE 2

| | | Resin | Resin |
|---|---|---|---|
| Ink | Dispersant Type | Level | Mw |
| A | Styrene Acrylic | Lower | Lower |
| | Acid Number 120 | | |
| B | Styrene Acrylic | Lower | Higher |
| | Acid Number 120 | | |
| C | Styrene Acrylic | Higher | Lower |
| | Acid Number 120 | | |
| D | Styrene Acrylic | Higher | Higher |
| | Acid Number 120 | | |
| E | Styrene Acrylic | Lower | Lower |
| | Acid Number 90 | | |
| F | Styrene Acrylic | Lower | Higher |
| | Acid Number 90 | | |

### Example 2—Comparative Magenta Ink Saturation

To investigate the different levels of steric stabilization, the various inks were printed on two different types of essentially plain print media that is not designed to enhance saturation by locking the colorant in the print media, i.e. non ColorLok® media. Namely, each ink was printed at 54% fill on both Hammermill Great White 30% recycled (GW30), and Staples Copy Paper (SCP). The results are shown in FIG. 2. As can be seen, by using relative lower sterically stabilization for the magenta pigment, saturation was increased. In other words, lowering the steric stabilization results in higher magenta saturation on non-ColorLok® media. These higher saturations can also be achieved without the use of fixers or other additives that may interfere or reduce printer performance.

While the present technology has been described with reference to certain examples, those skilled in the art will appreciate that various modifications, changes, omissions, and substitutions can be made without departing from the spirit of the disclosure. It is intended, therefore, that the disclosure be limited only by the scope of the following claims.

What is claimed is:

1. An ink composition, comprising:
from 1 wt % to 8 wt % pigment load, and
a polymer dispersant associated with pigment, the polymer dispersant having hydrophilic moieties and hydrophobic moieties, a molecular weight ranging from 5,000 Mw to 25,000 Mw, and an acid number from about 40 to about 180,
wherein the polymer dispersant to pigment weight ratio is less than 0.33.

2. The ink composition of claim 1, wherein the polymer dispersant to pigment weight ratio is from 0.1 to 0.29.

3. The ink composition of claim 1, wherein the polymer dispersant to pigment weight ratio is from 0.15 to 0.25.

4. The ink composition of claim 1, wherein the polymer dispersant has a weight average molecular weight from about 7,000 Mw to about 12,000 Mw.

5. The ink composition of claim 1, wherein the polymer dispersant to pigment weight ratio is from 0.15 to 0.25, the pigment load is from 2 wt % to 6 wt %, and the polymer dispersant has a weight average molecular weight from about 7,000 Mw to about 12,000 Mw.

6. The ink composition of claim 1, wherein the polymer dispersant comprises polymerized monomers of styrene and an acrylic acid, or styrene and a methacrylic acid, or styrene and an acrylic acid and a methacrylic acid.

7. The ink composition of claim 1, wherein the pigment is a magenta pigment.

8. A method of making an ink composition, comprising:
dispersing a pigment with a polymer dispersant, the polymer dispersant having hydrophilic moieties and hydrophobic moieties, a molecular weight ranging from 5,000 Mw to 25,000 Mw, an acid number from about 40 to about 180, wherein the polymer dispersant to pigment weight ratio is less than 0.33; and
admixing a liquid vehicle with the pigment and polymer dispersant to form the ink composition having a pigment load from 1 wt % to 8 wt %.

9. The method of claim 8, wherein the polymer dispersant to pigment weight ratio is from 0.1 to 0.29.

10. The method of claim 8, wherein the polymer dispersant to pigment weight ratio is from 0.15 to 0.25.

11. The method of claim 8, wherein the polymer dispersant has a weight average molecular weight from about 7,000 Mw to about 12,000 Mw.

12. The method of claim 8, wherein the polymer dispersant to pigment weight ratio is from 0.15 to 0.25, the pigment load is from 2 wt % to 6 wt %, and the polymer dispersant has a weight average molecular weight from about 7,000 Mw to about 12,000 Mw.

13. An ink set, comprising a magenta ink and at least one of a cyan ink, a yellow ink, or a black ink, the magenta ink, comprising:
from 1 wt % to 8 wt % of a magenta pigment load, and
a polymer dispersant associated with magenta pigment, the polymer dispersant having hydrophilic moieties and hydrophobic moieties, a molecular weight ranging from 5,000 Mw to 25,000 Mw, and an acid number from about 40 to about 180,
wherein the polymer dispersant to magenta pigment weight ratio is less than 0.33.

14. The ink set of claim 13, wherein the ink set comprises the cyan ink and the yellow ink.

15. The ink set of claim 13, wherein the polymer dispersant to pigment weight ratio is from 0.15 to 0.25, the pigment load is from 2 wt % to 6 wt %, and the polymer dispersant has a weight average molecular weight from about 7,000 Mw to about 12,000 Mw.
